(19) United States
(12) Patent Application Publication
(10) Pub. No.: US 2023/0126880 A1
(43) Pub. Date: Apr. 27, 2023

(54) RETROREFLECTIVE PIGMENTS AND PAINTS

(71) Applicant: BASF COATINGS GMBH, Münster (DE)

(72) Inventors: Markus MUNDUS, Münster (DE); Thomas KANTIMM, Münster (DE)

(21) Appl. No.: 17/907,678

(22) PCT Filed: Mar. 27, 2021
(86) PCT No.: PCT/EP2021/058058

§ 371 Date: Sep. 29, 2022

(30) Foreign Application Priority Data
Mar. 30, 2020 (EP) 20166898.5

(51) Int. Cl. C09D 5/33; C09D 7/40; C09D 175/04; C09D 133/08; C09D 7/61

(52) U.S. Cl. CPC C09D 5/004; C09D 7/61; C09D 7/67; C09D 7/70; C09D 133/08; C09D 175/04

(57) ABSTRACT

Disclosed herein are retroreflective pigments and paints including the retroreflective pigments.

### FIELD OF THE INVENTION

The present disclosure relates to retroreflective pigments and paints comprising the retroreflective pigments.

### BACKGROUND

Lidar (light detection and ranging) is a technology for detecting objects and measuring distances which emits laser radiation into a specific angular direction or angular range and detects the radiation scattered or reflected by an object for evaluating the distance between source and object by time-of-flight or frequency measurements. This method requires that a sufficiently high signal is scattered or reflected from the object and hits the detector of the Lidar system which is placed very close to its emitter. Objects coated with darker paints exhibit quite low reflectance at Lidar wavelengths, as the laser pulses are absorbed rather than being scattered or reflected. Objects coated with metallic paints exhibit highly specular reflection. Therefore, Lidar detectors might not be able to detect such objects or might produce erroneous distance data.

Retroreflection is a well-known principle that is widely applied (e.g., for traffic signs or safety clothing). Retroreflection ensures that incident radiation is reflected towards the emitter, thereby enhancing visibility of an object from the viewing point of the source.

US 2016/0146926 A1 discloses a system including a light detection and ranging (Lidar) device and a Lidar target. The Lidar device is configured to direct a light beam at the Lidar target. The system also includes a retroreflective material in contact with the Lidar target. In an embodiment, the retroreflective material includes a retro-reflective dust configured to be dusted off of the LIDAR target over a period of time. Alternatively, the retro-reflective material includes a retro-reflective paint, a retro-reflective coating, a retro-reflective tape, a retro-reflective cloth, a retro-reflective surface finish, or a combination thereof. In an embodiment, the retro-reflective material includes a retro-reflective structure which may include a corner cube or a retro-reflecting ball.

WO 2018/081613 A1 discloses a method for increasing a detection distance of a surface of an object illuminated by near-IR electromagnetic radiation. The method includes: (a) directing near-IR electromagnetic radiation from a near-IR electromagnetic radiation source towards an object at least partially coated with a near-IR reflective coating that increases a near-IR electromagnetic radiation detection distance by at least 15% as measured at a wavelength in a near-IR range as compared to the same object coated with a color matched coating which absorbs more of the same near-IR radiation, where the color matched coating has a ΔE color matched value of 1.5 or less when compared to the near-IR reflective coating; and (b) detecting reflected near-IR electromagnetic radiation reflected from the near-IR reflective coating.

US 2014/0154520 A1 describes a process for preparing embossed fine particulate thin metal flakes having high levels of brightness and color intensity. The reflective metal flakes which have been embossed by replicating a diffraction grating pattern having a monoruled embossing angle above 45° have a D50 average particle size at or above 75 µm and a flake thickness from about 50 nm to about 100 nm. The flakes have application to coatings and printing inks that produce extremely high brightness characterized as an optically apparent glitter or sparkle effect in combination with high color intensity or chromaticity.

WO 2006/116641 A2 discloses a process for preparing embossed fine particulate thin metal flakes having high levels of brightness and color intensity. The process comprises forming a release coat on a flexible polymeric carrier film, embossing the release coat with a diffraction grating pattern that is monoruled at an angle above 45°, vacuum metalizing the embossed release surface with a highly reflective metal such as aluminum, and solubilizing the metalized release coat in a solvent for removing the metal from the carrier to form embossed metal flakes that replicate the embossment pattern. The flakes are recovered from the solution containing the solvent and release coat polymer while avoiding high shear, particle sizing or other application of energy that would excessively break up the flakes, so that the D50 particle size of the flakes is maintained at or above 75 microns. The flakes have application to coatings and printing inks that produce extremely high brightness characterized as an optically apparent glitter or sparkle effect in combination with high color intensity or chromaticity.

WO 03/011980 A1 discloses diffractive pigment flakes including single layer or multiple layer flakes that have a diffractive structure formed on a surface thereof. The multiple layer flakes can have a symmetrical stacked coating structure on opposing sides of a reflective core layer, or can be formed with encapsulating coatings around the reflective core layer. The diffractive pigment flakes can be interspersed into liquid media such as paints or inks to produce diffractive compositions for subsequent application to a variety of objects.

US 2004/146641 A1 discloses a pigment comprising one or more spherical-shaped beads, wherein each spherical-shaped bead comprises one or more high aspect ratio particles encapsulated within an encapsulating material; a resinous composition comprising the pigment; and a method of preparing the pigment via suspension polymerization.

US 2008/107841 A1 discloses a reflective clear coat composition. which includes a clear coat composition including a polymeric binder comprised of one or more resins and reflective flakes having a reflectivity of at least 30% in at least a portion of the near infrared radiation (NIR) region of the solar spectrum and a reflectivity of 29% or less in at least a portion of the visible region of the solar radiation spectrum. The reflective clear coat composition can be cured onto an exterior cured paint surface of an automotive vehicle. The resulting cured clear coat composition may reduce the temperature generated within a vehicle passenger cabin while exposed to solar radiation.

It is an objective of the present disclosure to provide retroreflective pigments and paint comprising such retroreflective pigments, which can be used for producing coatings having enhanced reflectivity for electromagnetic radiation used in Lidar systems.

### BRIEF DESCRIPTION OF THE DRAWINGS

FIG. 1 shows a schematic drawing of an exemplary retroreflective pigment of the present disclosure;

FIG. 2 shows the simulated reflection of a coating comprising standard aluminum flakes over a perfect absorber substrate (state of the art);

FIG. 3 shows the simulated reflection of a coating comprising the retroreflective pigments of the present disclosure on a perfect absorber substrate;

FIG. 4 shows a comparison of the simulated reflection of a coating comprising standard aluminum flakes, a coating comprising aluminum flakes having a diffraction grating surface, and a coating comprising retroreflective pigments according to the present disclosure, each on a perfect absorber substrate;

FIG. 5 shows a comparison of the measured reflection of coatings comprising standard aluminum flakes and coatings comprising aluminum flakes having a diffraction grating surface, each on a strongly absorbing black substrate;

FIG. 6 shows a schematic drawing of an exemplary retroreflective pigment of the present disclosure having two retroreflective structures;

FIG. 7 shows a comparison of LIDAR reflection as a function of the angle of incidence of (1) a plane mirror made of silver, (2) a white coating, and (3) a silver-coated cube corner structure according to the present disclosure.

### SUMMARY OF THE INVENTION

The present disclosure provides effect pigments which retroreflect incident electromagnetic radiation in the direction of the radiation source. The surfaces of the retroreflective pigments of the present disclosure are mirror-like (at least at the intended wavelength regime, e.g., of Lidar); and the geometrical properties of the pigments result in retroreflection of incident radiation in the direction of the source of the incident radiation.

The present disclosure also provides paints comprising the retroreflective pigments and coatings produced from the paints.

### DETAILED DESCRIPTION

In the present disclosure, the concept of retroreflection is applied to effect pigments. Typically, such effect pigments are dispersed in paints to create special color or gloss effects. Metal flakes are widely used as effect pigments. Light incident on the effect pigments is reflected in nearly specular direction by the (approximately) flat surface of each individual flake.

In contrast, the flakes used in the present disclosure are three-dimensionally structured with retroreflective geometries. Thus, radiation incident upon the structured area of such flakes is retroreflected to the source and not in the specular direction. One example of a suitable effect pigment is a micrometer-size metal flake with a retroreflective surface structure.

Retroreflective pigments reflect incoming light in a narrow beam about the direction opposite to the direction of the incoming light. Retroreflection serves to make retroreflective objects much brighter than they would be with ordinary reflection, typically by a factor of 10 to 1000.

The directly measured value of retroreflectivity is the ratio of the retroreflected luminous intensity I (candela, cd) and the illuminance E (lux, Ix) at the plane of the object. It is called the coefficient of luminous intensity CIL. The unit is candela per lux.

In one embodiment, the retroreflective pigment of the present disclosure has a CIL value of more than 1 mcd×lx⁻¹, for instance, more than 10 mcd×lx⁻¹, or even more than 100 mcd×lx⁻¹. In one embodiment, the retroreflective pigment of the present disclosure has a CIL value in the range of from 5 to 500 mcd×lx⁻¹, e.g., 20 to 400 mcd×lx⁻¹, or 30 to 300 mcd×lx⁻¹.

In one embodiment, the retroreflective pigment of the present disclosure is comprised of a metallic material. In a particular embodiment, the retroreflective pigment of the present disclosure is comprised of aluminum. In another particular embodiment, the retroreflective pigment of the present disclosure is comprised of brass or bronze. In still another particular embodiment, the retroreflective pigment of the present disclosure is comprised of copper. In another particular embodiment, the retroreflective pigment of the present disclosure is comprised of silver. In yet another particular embodiment, the retroreflective pigment of the present disclosure is comprised of gold. In still another particular embodiment, the retroreflective pigment of the present disclosure is comprised of tin. In yet another particular embodiment, the retroreflective pigment of the present disclosure is comprised of zinc. In another particular embodiment, the retroreflective pigment of the present disclosure is comprised of lead. In another embodiment, the retroreflective pigment is comprised of a substrate material coated with a thin oxide layer.

In one embodiment, the retroreflective pigment of the present disclosure retroreflects light with a wavelength in the range of from 850 nm to 950 nm, e.g., 905 nm. In another embodiment, the retroreflective pigment of the present disclosure retroreflects light with a wavelength in the range of from 1500 nm to 1600 nm, e.g., 1550 nm.

In one embodiment, the retroreflective pigment of the present disclosure has a surface area in the range of from 100 µm² to 60,000 µm², for instance, 100 µm² to 10,000 µm². In the context of the present disclosure, the surface area is the area of one face of the substantially planar part of the metal flake. In one embodiment, the retroreflective pigment of the present disclosure has an equivalent diameter in the range of from 10 µm to 100 µm. The equivalent diameter d is obtained from the surface area A of one face of the retroreflective pigment using the formula d= (4A/_{π})^{½}.

In one embodiment, the retroreflective pigment is an elliptical metal flake, for instance, an aluminum flake, with a first main axis having a length in the range of from 20 µm to 100 µm, e.g., 40 µm, and a second main axis having a length in the range of from 10 µm to 70 µm, e.g., 25 µm. In a particular embodiment, the length of the first main axis is 40 µm and the length of the second main axis is 25 µm.

In another embodiment, the retroreflective pigment is a circular metal flake, e.g., an aluminum flake, with a diameter in the range of from 10 µm to 100 µm, e.g., 20 µm

In one embodiment, the metal flake has a material thickness in the range of from 20 nm to 1,000 nm, for instance, 200 nm to 300 nm, e.g., 250 nm. The term “material thickness” is used to indicate the thickness of the metal flake perpendicular to its largest surface(s).

In one embodiment, the retroreflective pigment is a micrometer-size metal flake with at least one retroreflective structure. In one embodiment, the metal flake features at least one retroreflective structure embossed into it. In a further embodiment, the metal flake features at least two retroreflective structures, at least one present in a front face of the metal flake, and at least one present in the reverse face of the metal flake.

In one embodiment, a cube corner structure is embossed into the center of the metal flake. In one embodiment, the base of the embossed structure forms an equilateral triangle having a side length in the range of from 2 to 30 µm, for instance, 5 to 30 µm, e.g., 17 µm, in the main plane of the flake. The retroreflective structure thus takes the form of a tetrahedron. In another embodiment, two identical cube corner structures are embossed into opposite sides of the metal flake, at a distance to each other. One cube corner structure is embossed into a front face of the metal flake, the other cube corner structure is embossed into a reverse face of the metal flake.

The retroreflective pigment of the present disclosure combines high surface reflectivity (due to its metallic surface) and directionality of the reflection (due to the retroreflective structure).

There is no limitation regarding applied geometry if the pigment exhibits (at least nearly) retroreflective properties. For instance, the retroreflective structure may also take the form of a retroreflective ball or bead; or it may combine sections of cube corner structures, in order to reduce dead areas near the corners that reduce the active retroreflective area. For instance, rows or clusters of individual microprisms tilted slightly in different directions can be used to spread the retroreflectivity out over a wider angle of incidence. Further, a rectangular section can be selected from the basic pyramid unit that excludes the dead corners, and an array of these smaller units butted up to each other can be assembled.

In one embodiment, the retroreflective pigment of the present disclosure is produced by embossing a thin metal foil, e.g., an aluminum foil. In a further embodiment, metal flakes, e.g., aluminum flakes, are embossed. In another embodiment, the retroreflective pigment of the present disclosure is produced by physical vapor deposition (PVD) of metal, e.g., aluminum, on a preform or on a substrate. In the context of the present disclosure, a preform is a support featuring a desired surface structure. In one embodiment, the preform is produced by different embossing techniques, and the embossed surface is subsequently metalized with a thin reflective metal film. To obtain the retroreflective pigment, the metal film is removed from the surface. In one embodiment, the preform is comprised of a heat resistant polymer. In the context of the present disclosure, a heat resistant polymer is a polymer that can withstand a temperature of at least 100° C. without melting or decomposing. Examples of suitable polymers include acrylic resins, acrylic copolymers, PVC, polystyrene, and polyesters, such as PET. In still another embodiment, production of the retroreflective pigment involves formation of a metal film on a glass substrate, e.g., a glass sheet or foil. The substrate does not necessarily need to be a preform. In a further embodiment, the metal film is not removed from the glass substrate.

The present disclosure also provides a paint comprising the retroreflective pigment of the present disclosure. The paint of the present disclosure can be used in coatings, e.g., industrial coatings, in particular, automotive coatings.

In one embodiment, the concentration of the retroreflective pigment in the paint is in the range of from 0.01 to 10 wt.-%, relative to the total weight of the paint.

In a further embodiment, the concentration of the retroreflective pigment in the paint is in the range of from 0.1 to 5 wt.-%, relative to the total weight of the paint, e.g., from 0.5 to 2 wt.-%, for instance, 1 wt.-%.

In one embodiment, the paint additionally comprises non-retroreflective effect pigments, such as flat metal flakes, iridescent particles, or interference pigments. In a further embodiment, a fraction of the effect pigments present in the paint, i.e., a metallic paint or an iridescent paint, is substituted by the retroreflective pigments of the present disclosure.

The retroreflective pigments of the present disclosure can be dispersed in combination with other effect pigments. They can even be used in coating layers positioned below layers containing scattering pigments (e.g., in solid coatings).

In one embodiment, the paint comprises a polyurethane resin. In another embodiment, the paint comprises an acrylic resin. In a further embodiment, the paint comprises a copolymer comprising urethane and acrylic functionalities.

The present disclosure also provides coatings which are obtained from the paints of the present disclosure. In one embodiment, the coating is an automotive coating. In another embodiment, the coating is a coating on a solid object comprised of, for instance, metal, wood, plastics, ceramics, or glass. In still another embodiment, the coating is a textile coating.

The retroreflective pigment is evenly distributed throughout the surface of the coating. In one embodiment, the fraction of the surface area of the coating covered by the retroreflective pigment is at least 0.01%, relative to the total surface area of the coating, for instance, at least 1%, or at least 5%. In one embodiment, the fraction of the surface area of the coating covered by the retroreflective pigment is in the range of from 0.01% to 90%, relative to the total surface area of the coating, e.g., from 1% to 70%, or from 3% to 50%, or from 5% to 35%, or even from 25% to 35%.

In one embodiment, the orientation of the flakes of the retroreflective pigment in the coating of the present disclosure is substantially parallel to the surface of the coating, i.e., the angle between the surface of the coating and the main plane of the flakes is (0°±4°).

In a particular embodiment, the retroreflective pigment is a micrometer-size metal flake with at least one retroreflective structure. In one embodiment, the metal flake has a mean diameter in the range of from 10 µm to 100 µm, e.g., 20 µm to 70 µm, and a material thickness in the range of from 20 nm to 1,000 nm. In one embodiment, the metal flake features at least one retroreflective structure embossed into it. In a further embodiment, the metal flake features at least two retroreflective structures, at least one present in the front face of the metal flake, and at least one present in the reverse face of the metal flake. In one embodiment, the at least one retroreflective structure is a cube corner structure and the base of the cube corner structure forms an equilateral triangle having a side length in the range of from 2 to 30 µm. In a further embodiment, the metal flake features at least two cube corner structures, at least one in a front face of the metal flake, and at least one in the reverse face of the metal flake.

In another particular embodiment of the coating, the retroreflective pigment is an elliptical metal flake with a first main axis having a length in the range of from 20 µm to 100 µm, and a second main axis having a length in the range of from 10 µm to 70 µm, and a material thickness in the range of from 20 nm to 1,000 nm, the metal flake featuring at least one retroreflective structure embossed into it, the embossed retroreflective structure being a cube corner structure and the base of the cube corner structure forming an equilateral triangle having a side length in the range of from 2 to 30 µm. In a further embodiment, the metal flake features two of the cube corner structures embossed into opposite faces of the metal flake.

As already mentioned above, the orientation of the flakes of the retroreflective pigment in the coating is substantially parallel to the surface of the coating. By using pigments comprising flakes having at least one cube corner structure on each of their two faces, it is made sure that at least one of the at least two cube corner structures always has the correct orientation for retroreflecting incident radiation.

The subject matter of the present disclosure is further described and explained with reference to the accompanying drawings.

### DETAILED DESCRIPTION OF THE DRAWINGS

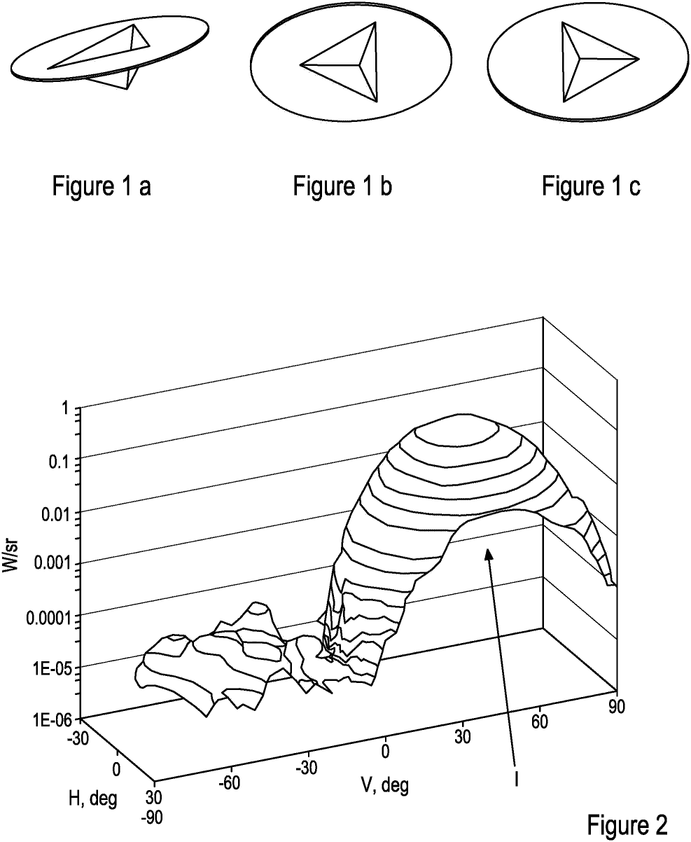

FIG. 1 shows a schematic drawing of an exemplary retroreflective pigment of the present disclosure. The retroreflective pigment is an aluminum flake having an elliptical shape with main axes of 40 µm and 25 µm, respectively. The thickness of the metal flake is 250 nm. A cube corner structure has been embossed in the aluminum flake. An incident light ray is reflected by all three inner surfaces of the cube corner structure, causing a retroreflection of the incident ray. The base of the tetrahedron structure produced by the embossing has the form of an equilateral triangle with 17 µm side length. FIG. 1 shows a tilted perspective side view a) of the retroreflective pigment; a bottom view b) of the retroreflective pigment; and a perspective top view c) of the retroreflective pigment.

FIG. 2 shows the simulated reflection (vertical axis in W/sr) of a coating comprising standard aluminum flakes on a perfect absorber substrate (state of the art). The data represents the reflection of a clear coat having 9,000 standard elliptical aluminum flakes with main axes of 40 µm and 25 µm, respectively, and a flat surface (i.e., without embossed structure) dispersed throughout the surface of the clear coat. The flakes are aligned substantially parallel to the surface of the coating, at an angle of 0° tilt (with +/-4° standard deviation), relative to the coating surface. The flakes cover approximately 5% of the total surface of the coating. The surface of the coating is illuminated at V=-45° angle of incidence, and the reflection from the coating surface from V=-90° to V=90°, relative to the surface normal, is shown in the diagram. Peak I represents the sum of the specular reflection at the interface of clear coat and air plus the specular reflection of the aluminum flakes.

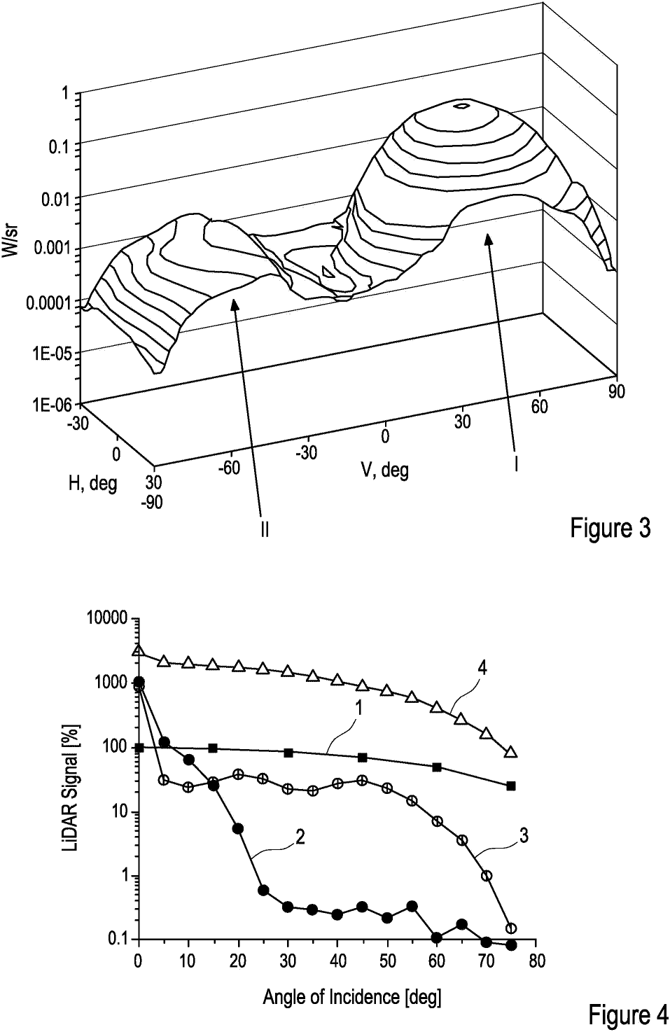

FIG. 3 shows the simulated reflection (vertical axis in W/sr) of a coating comprising the structured aluminum flakes of FIG. 1 on a perfect absorber substrate. The data represents the reflection of a clear coat having 9,000 aluminum flakes dispersed throughout the surface of the clear coat. The flakes are aligned substantially parallel to the surface of the coating, at an angle of 0° tilt (with +/-4° standard deviation), relative to the coating surface. The flakes cover approximately 5% of the total surface of the coating. The surface of the coating is illuminated at V=-45° angle of incidence, H=0°, and the reflection from the coating surface from V=-90° to V=90°, relative to the surface normal, is shown in the diagram. Peak I represents the sum of the specular reflection at the interface of clear coat and air plus the specular reflection of the aluminum flakes. Compared with FIG. 2, the intensity of Peak I is slightly reduced, as the total surface area of the aluminum flakes aligned in parallel to the coating surface is reduced by the embossed structure. Peak II is caused by the retroreflection from the structured aluminum flakes. According to this simulation, approximately 1% of the incident radiation is retroreflected.

Standard (thus, flat surface) aluminum flakes are used in FIG. 2, while structured aluminum flakes (according to the present disclosure) are used in FIG. 3. In both cases, a strong reflection towards the specular direction is observed (V=45°, H=0°). However, when the retroreflective-type effect pigments of the present disclosure are used, there is a strong increase of the signal reflected towards the source direction (V=-45°, H=0°) which is not observed for the standard effect pigments. This demonstrates that Lidar pulses incident on such a coating will be detected better in comparison to a coating using only standard effect pigments.

FIG. 4 shows a comparison of the simulated reflection of a Lidar signal having a wavelength λ of 905 nm from
a coating 2 comprising standard aluminum flakes,
a coating 3 comprising aluminum flakes having a diffraction grating surface (as described in US 2014/0154520 A1) with periodicity g=1.3 µm, assuming a diffraction effectivity of 20% for each order of diffraction from n=-2 to n=+2, and
a coating 4 comprising retroreflective pigments of the present disclosure, each on a perfect absorber substrate.

The relative intensity [%] of a reflected Lidar signal is depicted as a function of the angle of Lidar signal incidence [°], relative to the surface normal of the coating. The reflection curve of a Lambertian reference 1 also is shown in the diagram.

Curves 2, 3, 4 represent the simulated reflectance of a coating comprised of a 20 µm base coat layer on a perfect absorber substrate, covered by a clear coat layer. The base coat comprises 1 wt.-% of pigment, relative to the total weight of the base coat. The pigments are evenly distributed throughout the base coat layer and cover approximately 31% of the total surface area of the coating.

The reflectance of the Lambertian reference 1 decreases with increasing angle of incidence. The Lambertian reference 1 has an ideal diffusely reflecting surface which obeys Lambert’s cosine law.

Coating 2 comprising standard aluminum flakes shows high reflectivity at low angles of incidence, due to the specular reflection from the aluminum flakes which are oriented in parallel to the coating surface. As the angle of incidence increases, reflectivity quickly decreases and then drops to nearly zero.

Coating 3 comprising aluminum flakes having a diffraction grating surface (as described in US 2014/0154520 A1) with periodicity g=1.3 µm shows two local maxima of Lidar reflectivity at approximately 25 to 30° angle of incidence, and approximately 45°, respectively, due to the diffraction of the incident signal (n=-1 and n=-2, respectively).

Coating 4 comprising retroreflective pigments of the present disclosure (as shown in FIG. 1) shows a reflectance exceeding that of the Lambertian reference 1 over the whole range of the angle of incidence. For an angle of incidence of 5°, the reflectivity of coating 4 is 21 times the reflectivity of the Lambertian reference. Assuming an effectivity of retroreflection of 65% (as only those rays which are reflected by all three surfaces of the cube corner structure are reflected back in the direction of the incident rays), the reflectivity of coating 4 amounts to a theoretical value of 37 times the reflectivity of the Lambertian reference 1 when only considering total surface area of dispersed flakes in the coating. This is in the same range as the simulation results presented above, thereby demonstrating validity of the simulation results.

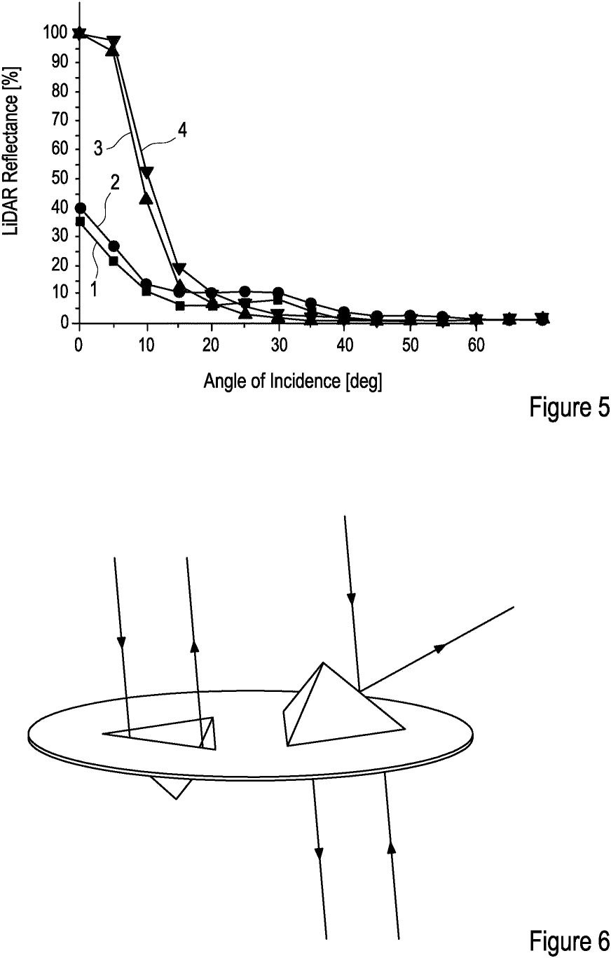

FIG. 5 shows a comparison of the measured reflection of coatings comprising standard aluminum flakes and coatings comprising aluminum flakes having a diffraction grating surface, each on a strongly absorbing substrate. The relative intensity [%] of a reflected Lidar signal is depicted as a function of the angle of Lidar signal incidence [°], relative to the surface normal of the coating.

Each curve represents the measured reflection of a Lidar signal having a wavelength λ of 905 nm from a multilayer coating on a black plastic substrate. The multilayer coating is comprised of, in sequence, a primer layer, a first 20 µm base coat layer BC1, a second 20 µm base coat layer BC2, and a clear coat layer.

Curve 1 is the measured reflection curve of a coating comprising 10 wt.-%, relative to the total weight of BC1, of carbon black dispersed in BC1, and 1.43 wt.-%, relative to the total weight of BC2, of aluminum flakes having a diffraction grating surface as described in US 2014/0154520 A1 (Metalure® Prismatic H-50720, ECKART GmbH, 91235 Hartenstein, Germany) dispersed in BC2.

Curve 2 is the measured reflection curve of a coating comprising 20 wt.-%, relative to the total weight of BC1, of a NIR-transparent black pigment dispersed in BC1, and 1.43 wt.-%, relative to the total weight of BC2, of aluminum flakes having a diffraction grating surface as described in US 2014/0154520 A1 (Metalure® Prismatic H-50720, ECKART GmbH, 91235 Hartenstein, Germany) dispersed in BC2.

Curve 3 is the measured reflection curve of a coating comprising 10 wt.-%, relative to the total weight of BC1, of carbon black dispersed in BC1, and 1 wt.-%, relative to the total weight of BC2, of standard aluminum flakes (Metalure® A-31017AE, ECKART GmbH, 91235 Hartenstein, Germany) dispersed in BC2.

Curve 4 is the measured reflection curve of a coating comprising 20 wt.-%, relative to the total weight of BC1, of a NIR-transparent black pigment dispersed in BC1, and 1 wt.-%, relative to the total weight of BC2, of standard aluminum flakes (Metalure® A-31017AE, ECKART GmbH, 91235 Hartenstein, Germany) dispersed in BC2.

Coatings 1 and 2 comprising aluminum flakes having a diffraction grating surface as described in US 2014/0154520 A1 show high reflectivity at low angles of incidence and an additional local maximum of Lidar reflectivity at approximately 25 to 30° angle of incidence. This local maximum appears when one diffraction order of the Lidar wavelength is directed towards the Lidar source.

Coatings 3 and 4 comprising standard aluminum flakes show high reflectivity at low angles of incidence, due to the specular reflection from the aluminum flakes which are oriented in parallel to the coating surface. As the angle of incidence increases, reflectivity quickly decreases and then drops to nearly zero.

FIG. 6 shows a schematic drawing of an exemplary retroreflective pigment of the present disclosure having two retroreflective structures. The retroreflective pigment is an aluminum flake having an elliptical shape with main axes of 40 µm and 25 µm, respectively. The thickness of the metal flake is 250 nm. Two cube corner structures have been embossed into opposite faces of the aluminum flake. The base of the tetrahedron structure produced by the embossing has the form of an equilateral triangle with 17 µm side length. FIG. 6 shows a perspective side view of the retroreflective pigment. As shown, incident light rays entering one of the cube corner structures are reflected by all three inner surfaces of the cube corner structure, causing a retroreflection of the incident ray. Incident light rays impinging onto the back of a cube corner structure are scattered. As the flake has a cube corner structure on each of its two faces, retroreflection will occur regardless of which face of the flake is irradiated.

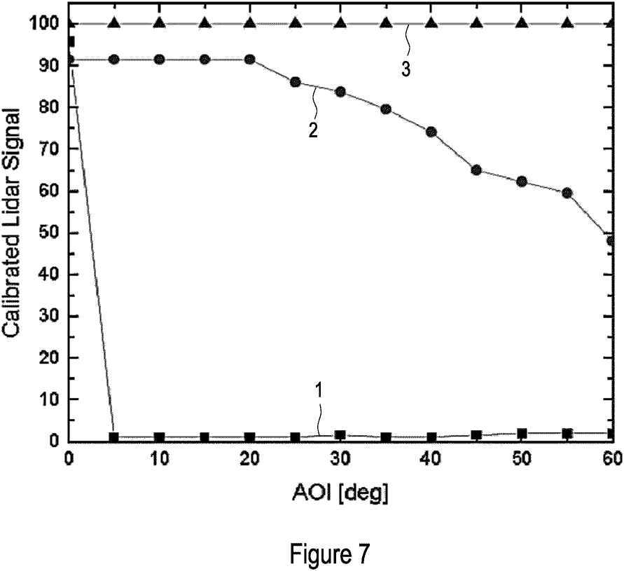

FIG. 7 is a graph showing the results of an experiment which demonstrates the potential of retroreflective structures of the present disclosure for Lidar signal enhancement. Three samples (1) to (3) were prepared.
Sample (1) was a Ag-coated Plane Mirror prepared by coating a PET-film (plane coating, no structure) with a UV-coat, and subsequently by silver (Ag) to produce a layer of approximately 120 nm thickness;
Sample (2) was a white basecoat sample with Clearcoat on top (with L*=95);
Sample (3) was a silver-coated cube corner structure sample prepared by coating a PET-film with an UV-coat featuring a surface with cube corner structures (~100% packing density, approximately 100 µm edge length of each cube corner element). The UV coat was subsequently coated with silver to produce an Ag layer of approximately 120 nm thickness.
The samples were irradiated with a Lidar Sensor emitting at 905 nm .

FIG. 7 shows the calibrated relative intensity [%] of the reflected Lidar signal as a function of the angle of incidence (AOI) [deg] for samples (1) to (3). A “Calibrated Lidar Signal” of 100% is equivalent to the signal level of a perfect diffuser surface at 0° angle of incidence (AOI). All signal intensities larger than 100% are set to an artificial maximum value of 100%. Thus, the data shown in the graph does not allow for a quantitative comparison of the signal intensities measured for the different samples. However, the data shows that the retroreflective structure (3) produces a strong measurement signal a) over a wide range of angles of incidence (AOI) and b) exceeding the signal of a white scattering surface (2). Consequently, the data demonstrates that a cube corner structure effectively enhances Lidar reflectivity.

1. A retroreflective pigment comprising a micrometer-size metal flake having a retroreflective structure.

2. The retroreflective pigment of claim 1, wherein the retroreflective pigment has a surface area in the range of from 100 µm² to 60,000 µm².

3. The retroreflective pigment of claim 1, is wherein the retroreflective pigment comprises a metal flake having a mean diameter in the range of from 10 µm to 100 µm, and a material thickness in the range of from 20 nm to 1,000 nm, wherein the metal flake includes at least one retroreflective structure.

4. The retroreflective pigment of claim 1, wherein the retroreflective structure is a cube corner structure and the base of the cube corner structure forms an equilateral triangle having a side length in the range of from 2 to 30 µm.

5. The retroreflective pigment of claim 4, wherein the metal flake includes at least two cube corner structures, at least one in a front face of the metal flake, and at least one in a reverse face of the metal flake.

6. The retroreflective pigment of claim 1, wherein the retroreflective pigment is obtained by embossing a thin metal foil.

7. The retroreflective pigment of claim 1, wherein the retroreflective pigment is obtained by physical vapor deposition (PVD) of metal on a preform or on a substrate.

8. The retroreflective pigment of claim 7, wherein the preform is comprised of a heat resistant polymer, and the substrate is comprised of glass.

9. The retroreflective pigment of claim 1, wherein the retroreflective pigment is comprised of aluminum.

10. A paint comprising the retroreflective pigment of claim 1.

11. The paint of claim 10, wherein the concentration of the retroreflective pigment in the paint is in the range of from 0.01 to 10 wt.-%, relative to the total weight of the paint.

12. The paint of claim 10 further comprising non-retroreflective effect pigments.

13. The paint of claim 10 further comprising an acrylic resin.

14. The paint of claim 10 further comprising a polyurethane resin.

15. A coating obtained from the paint of claim 10, wherein the retroreflective pigment is evenly distributed throughout the surface of the coating and the fraction of the surface area of the coating covered by the retroreflective pigment is at least 0.01%, relative to the total surface area of the coating.
